(19) United States
(12) Patent Application Publication
(10) Pub. No.: US 2023/0318726 A1
(43) Pub. Date: Oct. 5, 2023

(54) INTER-TOWER MIMO COMMUNICATION IN BROADCAST SYSTEMS

(71) Applicant: His Majesty the King in Right of Canada, as represented by the Minister of Industry, through the Co, Ottawa (CA)

(72) Inventors: Zhihong Hunter Hong, Kanata (CA); Liang ZHANG, Ottawa (CA); Wei LI, Kanata (CA); Yiyan WU, Kanata (CA); Sébastien LAFLÈCHE, Gatineau (CA); Douglas PRENDERGAST,, Ottawa (CA)

(73) Assignee: His Majesty the King in Right of Canada, as represented by the Minister of Industry, through the Co, Ottawa (CA)

(21) Appl. No.: 18/126,671

(22) Filed: Mar. 27, 2023

Related U.S. Application Data
(60) Provisional application No. 63/324,811, filed on Mar. 29, 2022.

(51) Int. Cl. H04H 20/06; H04B 7/0413; H04B 1/10

(52) U.S. Cl. CPC H04H 20/06; H04B 7/0413; H04B 1/10

(57) ABSTRACT

A communication apparatus for a transmitter tower station (TTS) of a broadcast system includes a first transmitter (Tx) antenna to transmit a broadcast signal to a plurality of customer receivers, and one or more second, directional Tx antennas to transmit a first ITC signal to another TTS. A Tx signal processor is coupled to the first Tx antenna and the one or more second Tx antennas to perform a MIMO encoding of the first ITC signal to transmit with, at least, the one or more second Tx antennas. At least two receiver (Rx) antennas and an Rx signal processor coupled thereto are provided to receive from another TTS, and to decode, a MIMO-encoded second ITC signal to extract ITC information therefrom.

This application claims priority from the U.S. Provisional Patent Application No. 63/324,811, entitled “MIMO INTEGRATION FOR WIRELESS BACKHAUL AND INTER-TOWER COMMUNICATIONS IN BROADCAST SYSTEMS” filed Mar. 29, 2022, which is incorporated herein by reference in their entirety.

### TECHNICAL FIELD

The present disclosure generally relates to wireless communication systems, and more particularly to wireless multicast/broadcast communication systems using a plurality of transmission towers.

### BACKGROUND

In traditional terrestrial broadcast systems, backhaul data is delivered from a broadcast gateway to broadcast transmitters via studio-to-transmitter links (STL). The STL links are usually implemented using wired connections or dedicated microwave links, both suffering from issues with availability and cost. For the legacy high-power-high-tower (HPHT) deployments, where a single tower covers an entire city, these solutions are affordable.

However, new generation terrestrial broadcasting systems, such as the Advanced Television Systems Committee (ATSC) 3.0, single-frequency-network (SFN) with multiple lower-power transmitters become more attractive in comparison to the traditional single-transmitter HPHT system, in order to deliver mobile services to portable/handheld and indoor receivers, and to support higher service quality. With the number of transmitters increasing, the existing STL solutions quickly become unaffordable. To address this challenge, a one-way wireless in-band backhaul technology to feed broadcast SFN transmitters has been described in U.S. Pat. No. 10,771,208, which is incorporated herein by reference for all purposes.

US Patent Publication 2022/0159650, which is incorporated herein in its entirety, discloses a broadcast communication system including a plurality of transmitter tower stations (TTS) configured to exchange inter-tower communication (ITC) signals to support a wireless ITC network (ITCN). Several ITCN-integrating broadcast systems operating in the same or different frequency band may be interconnected to support an integrated inter-tower wireless communication network. Each TTS includes a transmitter (Tx) antenna, at least one receiver (Rx) antenna, and an ITCN server configured to form outgoing ITC signals for transmitting with the Tx antenna and to process incoming ITC signals received with at least one Rx antenna. Each of the TTSs is configured to multiplex outgoing ITC signals with broadcast services signals prior to the transmitting and to detect the incoming ITC signals in a wireless signal received with at least one Rx antenna.

### BRIEF DESCRIPTION OF THE DRAWINGS

Embodiments disclosed herein will be described in greater detail with reference to the accompanying drawings, which are not to scale, in which like elements are indicated with like reference numerals, and wherein:

FIG. 1 is a schematic diagram illustrating a terrestrial broadcast system configured for inter-tower communications (ITC) in a MIMO format;

FIG. 2 is a schematic block diagram of a broadcast transmitter (Tx) configured for out-of-band (OB) MIMO transmission of ITC signals;

FIG. 3 is a schematic block diagram of a TTS receiver (Rx) configured for reception of the OB MIMO transmitted ITC signals;

FIG. 4 is a schematic diagram illustrating example broadcast and ITC signal transmission spectra for OB transmission;

FIG. 5 is a schematic block diagram of a broadcast transmitter configured for TDM MIMO transmission of ITC signals;

FIG. 6 is a schematic block diagram of a TTS receiver configured for reception of TDM MIMO-transmitted ITC signals;

FIG. 7A is a schematic diagram of a TDM signal combining single-layer broadcast and MIMO signals;

FIG. 7B is a schematic diagram of a TDM signal combining two-layer broadcast signal and a single-layer MIMO signal;

FIG. 7C is a schematic diagram of a TDM frame structure for signals illustrated in FIGS. 7A and 7B;

FIG. 8 is a schematic block diagram of a broadcast transmitter configured for TDM 3×3MIMO transmission of ITC signals;

FIG. 9 is a schematic block diagram of a broadcast transmitter configured for LDM 2×2MIMO transmission of ITC signals;

FIG. 10 is schematic block diagram of a TTS receiver configured for reception of LDM 2×2MIMO-transmitted ITC signals;

FIG. 11A is a schematic diagram of a two-layer LDM signal including broadcast and MIMO signals in different LDM layers;

FIG. 11B is a schematic diagram of a three-layer LDM signal including a two-layer broadcast signal and a MIMO signal in a third LDM layer;

FIG. 12A is a schematic diagram of a pilot signal structure for two-layer pilot encoding of an LDM signal transmitted by different Tx antennas using a 2×2MIMO format;

FIG. 12B is a schematic diagram of a pilot signal structure for two-layer pilot encoding of an LDM signal transmitted by different Tx antennas with an NP pilot in a MIMO-transmitting LDM layer;

FIG. 12C is a schematic diagram of a pilot signal structure for two-layer pilot encoding of an LDM signal transmitted by different Tx antennas with a WH pilot in a MIMO-transmitting LDM layer;

FIG. 13 is a flowchart of a method for receiving ITC signals co-transmitted with a broadcast signal in a lower LDM layer;

FIG. 14 is a schematic block diagram of a broadcast transmitter configured for LDM 2×2MIMO transmission of broadcast and ITC signals using single-layer pilot encoding;

FIG. 15 is a schematic diagram illustrating a structure of the LDM signal transmitted by the broadcast transmitter of FIG. 14;

FIG. 16 is a schematic block diagram of a broadcast transmitter configured for LDM 2×2MIMO transmission of ITC signals combined with broadcast signals using two additional Tx antennas;

FIG. 17 is a schematic block diagram of a broadcast transmitter configured for LDM 3×3MIMO transmission of ITC signals combined with broadcast signals using two additional Tx antennas;

FIG. 18 is a schematic block diagram of a broadcast transmitter configured for independent transmission of broadcast and ITC signals using broadcast and directional antennas transmitting in different-polarizations;

FIG. 19 is a schematic diagram illustrating a combined TDM/LDM multiplexing of MIMO and broadcast (ATSC 3.0 compliant SISO) signals.

### DESCRIPTION

The following acronyms may be used herein:
FIM Fully Integrated MIMO (MIMO Satisfying ATSC Standards)
ATSC Advanced Television Systems Committee
FDM Frequency Division Multiplexing
FFT Fast Fourier Transform
FI Frequency Interleaver
GI Guard Interval
IDL In-Band Distribution Link
ITC Inter-Tower Communication
IITWN Integrated Inter-Tower Wireless Network
ITCN Inter-Tower Communication Network
LDM Layered Division Multiplexing
MIMO Multi-Input Multi-Output
MP MIMO Pilot
NP Null Pilot
PIM Partially Integrated MIMO
SISO Single-Input Single-Output
SM Spatial Multiplexing
SP SISO Pilot
TDM Time Division Multiplexing
TI Time Interleaver
WH Walsh-Hadamard

Embodiments described herein relate to terrestrial single-frequency broadcast systems including a plurality of broadcast stations, which are typically provided on transmission towers and referred to herein as transmitter tower stations (TTSs), and to devices and methods for multi-input multi-output (MIMO) transmission and reception of inter-tower communication (ITC) signals in such broadcast systems. The use of MIMO, rather than SISO, for transmission of ITC signals between different TTSs for backhaul and other non-broadcast services delivery may potentially provide better bandwidth efficiency and higher throughput than SISO communication formats. The term “TTS” refers to broadcast stations equipped with antennas located at dedicated transmission towers as well as other suitably tall structures, e.g., on the roofs of high-rise buildings in a city environment.

The description below may refer to ATSC 3.0 standards to deliver broadcast TV services; however, embodiments described herein are not limited to ATSC 3.0 compliant systems. Embodiments that use an ATSC 3.0 compliant MIMO communication format for ITC signal transmission, such as e.g. 2×2 MIMO, may be referred to as fully-integrated MIMO (FIM). Embodiments wherein ITC signals are transmitted using a non-ATSC compliant MIMO communication format that is however backward compatible with legacy ATSC-compliant user equipment, such as e.g., single-antenna DTV receivers, may be referred to as partially-integrated MIMO (PIM).

An aspect of the present disclosure provides a communication apparatus for a transmitter tower station (TTS) of a broadcast communication system (BCS), the apparatus comprising: a first transmitter (Tx) antenna configured to transmit a broadcast signal to a plurality of customer receivers; one or more second Tx antennas configured to transmit a first ITC signal to another TTS; a Tx signal processor coupled to the first Tx antenna and the one or more second Tx antennas and configured to perform a multi-input multi-output (MIMO) encoding of the first ITC signal to transmit with, at least, the one or more second Tx antennas; at least two receiver (Rx) antennas for receiving, from the another TTS or a third TTS, wireless signals comprising a MIMO-encoded second ITC signal; and an Rx signal processor configured to decode the MIMO-encoded second ITC signal to extract ITC information therefrom.

In some implementations, the first Tx antenna and at least one of the one or more second Tx antennas may be configured to transmit in orthogonal polarizations. In some implementations, the first Tx antenna and at least one of the one or more second Tx antennas may be configured to transmit in a same polarization. In some implementations, the first Tx antenna and at least one of the one or more second Tx antennas may be configured to transmit in two orthogonal polarizations.

In any of the above implementations, the first Tx antenna may be an omni-directional antenna. In any of the above implementations, the one or more second Tx antennas may comprise a directional Tx antenna. In some implementations, the directional Tx antenna may have at least 5 dB lower antenna gain than the first Tx antenna. The apparatus may be configured for asymmetrical MIMO transmission of the first ITC signal by the first Tx antenna and the one or more second Tx antennas, wherein in operation each of the one or more second Tx antennas transmit at an at least 5 dB lower power than the first Tx antenna. In some implementations, each of the one or more second Tx antennas may be a directional antenna. In some implementations, the Tx signal processor may be configured to adjust the transmission power of the directional Tx antenna so that the another TTS receives approximately equal signal power from at least one of the one or more second Tx antennas and the first Tx antenna. In any of the above implementations, the Tx signal processor may comprise a gain control unit for adjusting a transmission power of the one or more second Tx antennas.

In any of the above implementations, the apparatus may be configured to transmit the broadcast signal with the first Tx antenna and at least one of the one or more second Tx antenna.

In any of the above implementations, the Tx signal processor may be configured to use time-division multiplexing (TDM) to multiplex the broadcast signal and the first ITC signal. In any of the above implementations, the Tx signal processor may be configured to combine the first ITC signal with the broadcast signal using layered division multiplexing to generate a first layered division multiplexed (LDM) signal. In some implementations, the first LDM signal may comprise the broadcast signal in a first LDM layer and the first ITC signal in a second LDM layer. In some implementations, the first LDM signal may comprise a first pilot signal in the first LDM layer and a second pilot signal in the second LDM layer.

In any of the above implementations, the one or more second Tx antennas comprise two directional Tx antennas, the Tx signal processor being configured to MIMO-encode the first ITC signal for transmitting with the first Tx antenna and the two directional Tx antennas.

In any of the above implementations, the Rx signal processor may be configured to extract, from the received MIMO-encoded signal, a feedback signal for adjusting the transmission power of the one or more second Tx antennas.

In any of the above implementations, the Rx signal processor may be configured to process a received LDM signal comprising first and second LDM layers, the first and second LDM layers comprising first and second pilot signals respectively, the second LDM layer comprising the received MIMO-encoded second ITC signal. In some implementations, the Rx signal processor may be configured to: detect a first-layer signal transmitted in the first LDM layer using the first pilot signal, at least partially cancel the detected first-layer signal from the received LDM signal to obtain a residual signal, and to detect the MIMO-encoded second ITC signal in the residual signal using the second pilot signal.

In any of the above implementations, the Rx signal processor may be configured to approximately cancel an interference signal from the one or more Tx antennas based, at least, on a copy of a signal generated by the Tx signal processor for transmitting with the one or more Tx antennas of the same TTS. In any of the above implementations, the Rx signal processor may comprise a self-interference cancellation unit. In some implementations, the Rx signal processor may comprise a self-interference cancellation unit, a channel estimation unit, and a MIMO decoding unit. The self-interference cancellation unit may be configured to approximately cancel an interference signal from the one or more Tx antennas based, at least, on feedback from at least one of the channel estimation unit and the MIMO decoding unit.

A related aspect of the present disclosure provides a method for a transmitter tower station (TTS) of a broadcast communication system (BCS), the method comprising: transmitting a broadcast signal to a plurality of customer receivers with a first transmitter (Tx) antenna; performing a multi-input multi-output (MIMO) encoding of a first inter-tower communication (ITC) signal; transmitting the MIMO-encoded first ITC signal to another TTS with, at least, one or more second Tx antennas; receiving wireless signals with two or more Rx antennas, the wireless signals comprising a MIMO-encoded second ITC signal transmitted by the another TTS or a third TTS; and decoding the MIMO-encoded second ITC signal to extract ITC information therefrom.

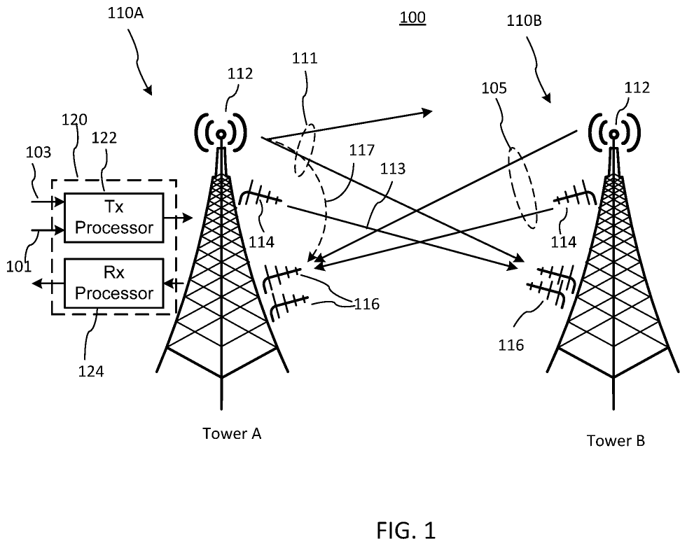

With reference to FIG. 1, a broadcast communication system 100 includes a plurality of transmitter tower stations (TTS) 110, represented in FIG. 1 with a first TTS 110A and a second TTS 110B. The TTS 110A includes a first transmitter (Tx) antenna 112, typically mounted close to a top of a transmission tower (“tower A”), for transmitting at least a broadcast signal 101 to a plurality of customer receivers (not shown). The first Tx antenna 112, which may also be referred to herein as the broadcast Tx antenna 112 or the main Tx antenna, is typically omnidirectional, i.e. it transmits a wireless signal 111 carrying the broadcast signal 101, in substantially all directions (i.e. approximately 3600 radiation pattern), so as to reach end-user receivers located in various directions from the tower A.

The TTS 110A is further equipped with at least one additional, second Tx antenna 114, which may also be mounted on the same transmission tower A. The at least one second Tx antenna 114 is configured for wirelessly transmitting an ITC signal 103 to another TTS, e.g. the TTS 110B of a transmission tower B, using a MIMO communication format. The ITC signal 103 may also be referred to as the first ITC signal. The at least one second Tx antenna 114, which may also be referred to as the tower-to-tower (T2T) Tx antenna(s), may be a lower-power directional Tx antenna configured to transmit a wireless signal 113, which may comprise the ITC signal 103, in the direction of the second TTS 110B that is equipped for MIMO reception. The main lobe of a radiation pattern of the Tx antenna 114 may be, e.g., about 300 wide, or narrower. The additional Tx antenna(s) 114 may be smaller in size than the broadcast Tx antenna 112, and have a lower transmission power, e.g., at least 5 dB lower, or at least 7 dB lower, or at least 10 dB lower than the transmission power of the broadcast Tx antenna 112. Here, “transmission power” refers to a total power of the wireless signal the Tx antenna typically transmits in a normal operation regime. In an example embodiment, the broadcast Tx antenna 112 and the additional Tx antenna(s) may be configured to transmit in horizontal and vertical polarizations, respectively.

The TTS 110A is further equipped with at least two receiver (Rx) antennas 116, which may also be mounted on the same transmission tower A. The Rx antennas 116 are configured for receiving MIMO-encoded second ITC signals 105 from the TTS 110B. The Rx antennas 116 may also be directional antennas aimed at the TTS 110B. In some embodiments the Rx antennas 116 may be directional antennas aimed at a third TTS (not shown) to receive MIMO-encoded signals therefrom.

The TTS 110A is further provided with a communication apparatus 120 (“transceiver 120”) including a Tx signal processor 122 and an Rx signal processor 124. The Tx signal processor 122 is coupled to the Tx antennas 112, 114 for transmitting the broadcast and ITC signals 101, 103 therewith, and is configured to MIMO-encode the first ITC signal 103 to transmit with, at least, the one or more second Tx antennas 114. The Rx signal processor 124 is coupled to the Rx antennas 116 to receive signals therefrom, and is configured to detect and decode the MIMO-encoded second ITC signal 105 from the received signals to extract ITC information therefrom.

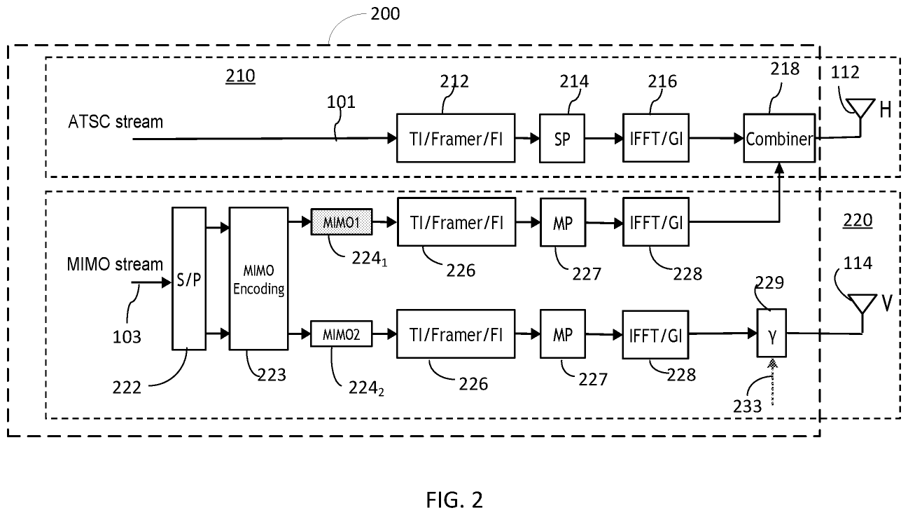

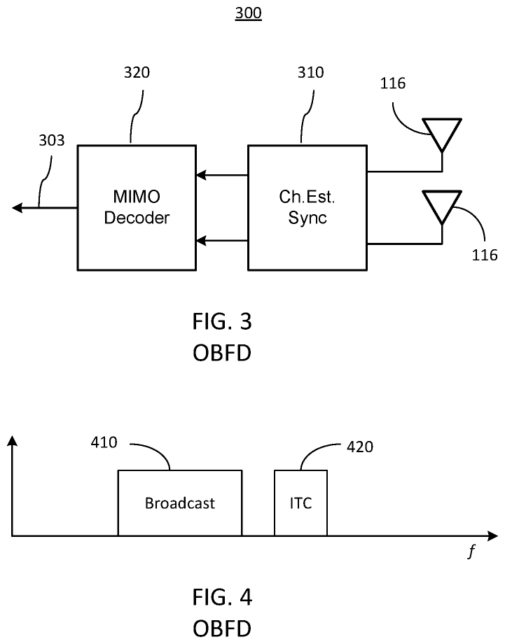

Referring to FIGS. 2 and 3, the Tx and Rx signal processors 122 and 124 of the communication apparatus 120 may be embodied, e.g., with a Tx signal processor 200 and an Rx signal processor 300, receptively. In this embodiment the first ITC signal 103 is transmitted out-of-band (OB) of the broadcast signal 101. The OB transmission is schematically illustrated in FIG. 4, which shows an example transmission spectrum of the TTS 110A in such embodiments. Here, the transmission spectrum 410 of the broadcast signal 101 does not substantially overlap a spectrum 420 of the ITC signal 103. In this embodiment, the broadcast and ITC signals 101, 103 may be separated and individually processed at the receiver using spectral filters.

Referring to FIG. 2, the Tx signal processor 200 includes a broadcast signal processing chain 210 for processing the broadcast signal 101 and a MIMO signal processing chain 220 for processing the ITC signal 103. The broadcast signal processing chain 210 may be, e.g. in accordance with ATSC 3.0 standards specification. In the illustrated embodiment the broadcast signal processing chain 210 includes a framer 212, a SISO pilot (SP) inserter 214, and an IFFT processor 216. The framer 212 may be configured to perform time-domain interleaving (TI) and frequency-domain interleaving (FI) of the incoming data. The IFFT processor 216 may be configured to perform, e.g., orthogonal frequency division multiplexing (OFDM) and guard interval insertion on an input digital signal to generate an OFDM waveform carrying the broadcast signal 101. The IFFT processor 216 may be followed by a combiner 218 to add an out-of-band (OB) OFDM waveform carrying a MIMO-encoded ITC data sub-stream 224₁ (“MIMO1”) for OB transmission, e.g., as illustrated in FIG. 4.

In the MIMO signal processing chain 220, the ITC signal 103 is first converted to N≥2 parallel data streams by a serial-to-parallel (S/P) signal converter 222, which are then MIMO-encoded by the MIMO encoder 223 to provide N parallel MIMO-encoded ITC data sub-streams MIMO1, MIMO2, . . . , MIMON. In the illustrated embodiment N=2, and the ITC signal 103 undergoes a 2×2 MIMO encoding by the MIMO encoder 223 to produce two different MIMO-encoded ITC data sub-streams 224₁ (“MIMO1”) and 224₂ (“MIMO2”). Each of these—differently-encoded MIMO sub-streams may then undergo substantially same signal processing as the broadcast signal 210, being successively processed by a framer 226, a MIMO-pilot (MP) inserter 227, and an IFFT processor 228. The framers 226 and the IFFT processors 228 may be as described above with reference to the framer 212 and the IFFT processor 216. The IFFT processor 228 may be configured to generate OFDM waveforms in a different frequency band than the IFFT processor 216 operating on the broadcast signal 101. The MIMO encoder 223 and the MIMO pilots (MP) inserter 227 may be configured e.g. as specified in the ATSC 3.0 standards. The MP insertion units 227 may be configured, e.g., to perform one of the null pilot (NP) encoding and the Walsh-Hadamard (WH) encoding that are specified in the ATSC 3.0 standards, to add scattered pilot patterns to the OFDM waveform. The MIMO pilots “MP” may be regularly inserted at the same time/frequency positions scattered within an OFDM symbol or frame as the SISO pilots “SP”, but may be modified in amplitude and/or phase compared to the SISO pilots. The MP inserters 227 operating at the MIMO-encoded sub-streams MIMO1 and MIMO2 may be configured to insert pilot sub-sets into different MIMO-encoded sub-streams that are orthogonal in phase or amplitude.

One of the MIMO-encoded ITC data sub-streams, e.g. MIMO1 224₁, is then combined with the broadcast signal by the combiner 218 to be wirelessly transmitted by the broadcast Tx antenna 112. The other of these MIMO-encoded ITC data sub-streams, e.g. MIMO2 224₂, is then optionally adjusted in power by a power control module 229, and passed to the second Tx antenna 114 for wireless transmission therewith. The ITC signal 103 is thus transmitted both by the main, i.e., broadcast, Tx antenna 112 and the additional, second Tx antenna 114 using a MIMO communication format. The power control unit 229 may coordinate the power output of the second Tx antenna 114 with that of the first Tx antenna, e.g. to approximately equalize wireless signals from the Tx antennas 112, 114 in power at the receiver of the second, target TTS, e.g. the TTS 110B of FIG. 1; here, “approximately” means that the power difference at the receiver is at most 20% of the received power of the broadcast signal. In some embodiments, the power control unit 229 may vary the transmission power responsive to a feedback signal 233 from a second, “partner” TTS that is the target of the ITC transmission (e.g. TTS 100B of FIG. 1).

Referring now to FIG. 3, the Rx signal processor 300 includes a channel estimation and synchronization unit 310 followed by a MIMO decoder 320. The channel estimation and synchronization unit 310 is connected to the two Rx antennas 116 to receive signals therefrom, and is configured to perform channel estimation and signal synchronization to detect a received MIMO-encoded ITC signal, e.g., the ITC signal 105 from the second TTS 110B (FIG. 1). The MIMO decoder module 320 decodes the received MIMO-encoded data streams and outputs a decoded ITC signal 303, which reproduces the ITC signal transmitted by a “partner” TTS at which the Rx antennas 116 are aimed, e.g., the second ITC signal 105 transmitted by the TTS 110B (FIG. 1). The received ITC signal 303 may then be processed to extract ITC information therefrom. In some embodiments, the Rx signal processor 300 may be configured to extract, from the received MIMO-encoded signal, a feedback signal for adjusting the transmission power of the one or more second Tx antennas of the co-located Tx signal processor (e.g. the second Tx antenna 114 of FIG. 2). The end-user equipment (UE) may not be equipped to decode, and may filter out the MIMO signal it receives out-of-band of the broadcast signal. This implementation may thus comply with the ATSC 3.0 standard.

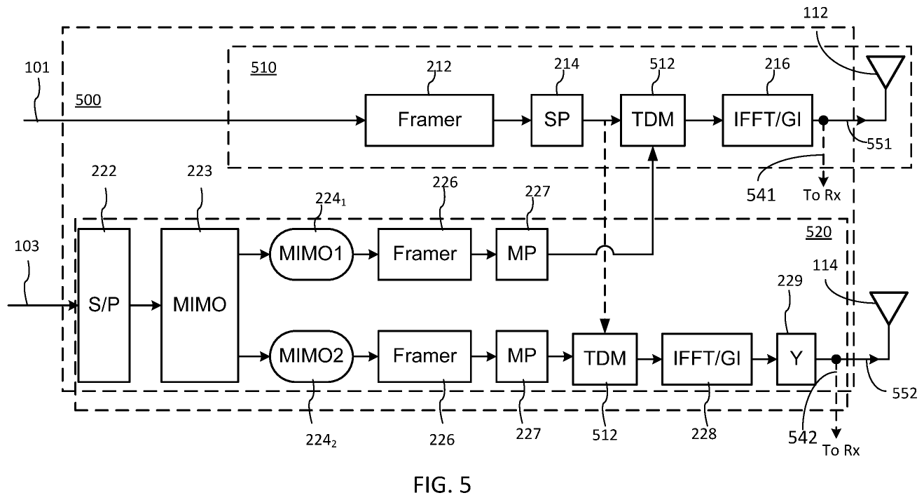

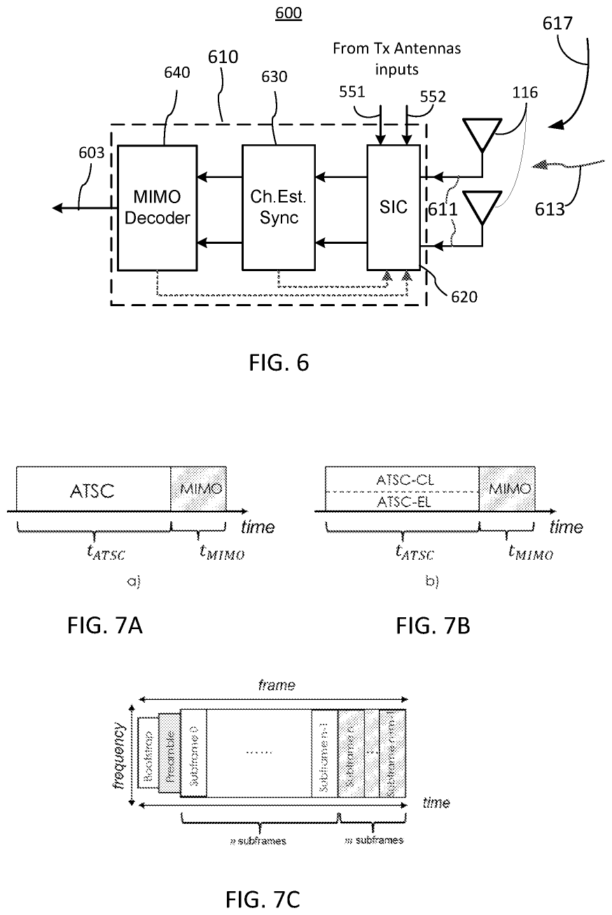

FIGS. 5 and 6 illustrate an example embodiment of a communication apparatus 120 of the TTS 110A, in which the ITC signals 103 are MIMO-encoded and time-multiplexed with the broadcast signals 101 using time-division multiplexing (TDM). FIG. 5 shows a schematic block diagram of a Tx signal processor 500, which may embody the Tx signal processor 122 of FIG. 1. FIG. 6 shows a schematic block diagram of a MIMO receiver 600 including an Rx signal processor 610, which may embody the Rx signal processor 124 of FIG. 1.

Referring to FIG. 5, the Tx signal processor 500 includes a broadcast signal processing chain 510 and a MIMO signal processing chain 520; these signal processing chains include several elements that perform substantially same functions as the corresponding elements shown in FIG. 2 that are indicated with same reference numerals. The broadcast signal processing chain 510 may be identical to the broadcast signal processing chain 210 described above, except having a time-division (TD) multiplexer 512 upstream of the IFFT processor 216 that replaces the combiner 218 downstream of the IFFT processor 216 (FIG. 2).

Similarly, the MIMO signal processing chain 520 may be the same as the MIMO signal processing chain 220 described above, except that one of the MIMO-encoded data sub-streams, e.g. the MIMO1 data sub-stream 224₁, is being time-division multiplexed with the broadcast signal by the TD multiplexer 512 for transmitting by the broadcast Tx antenna 112. The other of the MIMO-encoded ITC data sub-streams, e.g., the MIMO2 data sub-stream 224₂, is processed as described above for transmitting with the second Tx antenna 114. The MIMO signal processing chain 520 may further include a second TD multiplexer 512, e.g. prior to the IFFT processor 216, to time-division multiplex the transmission of the MIMO-encoded signal sub-stream 224₂ by the second Tx antenna 114 with the broadcast signal 101, so that both MIMO-encoded sub-streams 224₁, 224₂ are transmitted in a same dedicated MIMO time slot. In the illustrated embodiment, the broadcast signal 101 is TDM-added, without MIMO-encoding, to the ITC data sub-stream MIMO1 for transmitting in a broadcast signal time slot. The transmission power of the MIMO sub-stream MIMO2 224₂ transmitted by the second Tx antenna 114 may be adjusted by the power control module 229.

In this embodiment, the ITC signal 103 is thus transmitted in a different, preferably non-overlapping, time slot than the broadcast signal 101, by both by the main, i.e. broadcast, Tx antenna 112 and the additional, second Tx antenna 114 using a MIMO communication format.

FIGS. 7A-7C illustrate example signal structures for the TDM-MIMO Tx embodiment described above with reference to FIG. 5. In this embodiment the MIMO-encoded ITC signal and the broadcast, e.g. ATSC 3.0 compliant, signal are transmitted in separate time slots, as controlled by, e.g., the TD multiplexers 512. The broadcast signal 101, e.g. an ATSC 3.0 signal, is transmitted in a time slot t_{ATSC} reserved for broadcast, either as a one-layer signal as illustrated in FIG. 7A, or as a two-layer LDM signal as illustrated in FIG. 7B. The ITC signal 103 is transmitted in a different, MIMO-dedicated time slot t_{MIMO}, by the Tx antennas 114 and 112 operating as MIMO antenna array.

FIG. 7C illustrates an example frame structure of the TDM signal that may be generated by the Tx signal processor 500. The frame may include n subframes carrying the broadcast, e.g. ATSC, signal, flowed by m subframes carrying the ITC signal; here n and m are integers that are greater than 1. During the time slot t_{ATSC}, from subframe 0 to n−1, only the broadcast, e.g. ATSC, signal is transmitted, either by the main Tx antenna 112 only, or by both the main Tx antenna 112 and the second Tx antenna 114. In the latter case, both Tx antennas 112, 114 may transmit the same broadcast (ATSC) signal, without MIMO encoding.

During the MIMO time slot t_{MIMO}, from subframe n to n+m−1, the Tx antennas 112, 114 transmit different sub-streams of the MIMO-encoded ITC signal. The MIMO-encoded ITC signal is to be received by a suitably-configured, typically non-consumer, MIMO receiver, such as shown in FIG. 6. The end-user equipment (UE), which typically has only one Rx antenna, may not be equipped to decode, and may ignore, the signal it receives during the MIMO-dedicated time slots t_{MIMO}. This implementation complies with the ATSC 3.0 standard.

Referring now back to FIG. 6, the Rx signal processor 610 is configured to process signals 611 received from each of the Rx antennas 116 to detect an ITC signal transmitted by another, “partner” TTS, e.g. the second ITC signal 105 transmitted by the TTS 110B (FIG. 1). Signals 611 received by the Rx signal processor 610 from the Rx antennas 116 may include a TDM signal 613 from the other TTS carrying the second ITC signal 105 in a dedicated time slot, and a self-interference signal 617 from the co-located broadcast transmitter, e.g., the broadcast transmitter illustrated in FIG. 5.

The Rx signal processor 610 is configured to receive TDM MIMO-encoded ITC signals such as that generated by the Tx signal processor 500 and illustrated in FIGS. 7A-7C. The Rx signal processor 610 includes a self-interference cancellation (SIC) unit 620, which is connected to the two Rx antennas 116 to receive signals therefrom. In some embodiments the SIC unit 620 may further be connected to antenna-outputs 541, 542 of the Tx signal processing chains 510, 520 to receive copies of corresponding Tx antenna signals 551, 552 prior to their transmission by the respective Tx antennas 112, 114. The SIC unit 620 may be configured to use the copies of the Tx signals 551, 552 to detect and approximately cancel the contribution of self-interference signals 617 from the co-located Tx antennas 112, 114 in the wireless signal received by the Rx antennas 116.

The SIC unit 620 is followed by a channel estimation and synchronization unit 630 and a MIMO decoder 640, which may be embodiments of the channel estimation and synchronization unit 310 and the MIMO decoder 320. The MIMO decoder 640 decodes received MIMO-encoded data streams and outputs a decoded ITC signal 603 reproducing an ITC signal (e.g. the second ITC signal 105, FIG. 1), transmitted from the partner TTS (e.g. TTS 110B, FIG. 1). The decoded ITC signal 603 may then be processed to extract ITC information therefrom. In some embodiments, outputs of the channel estimation and synchronization unit 630 and/or the MIMO decoder 640 may be fed back to the SIC unit 620 to assist in the cancellation of the self-interference signal 617.

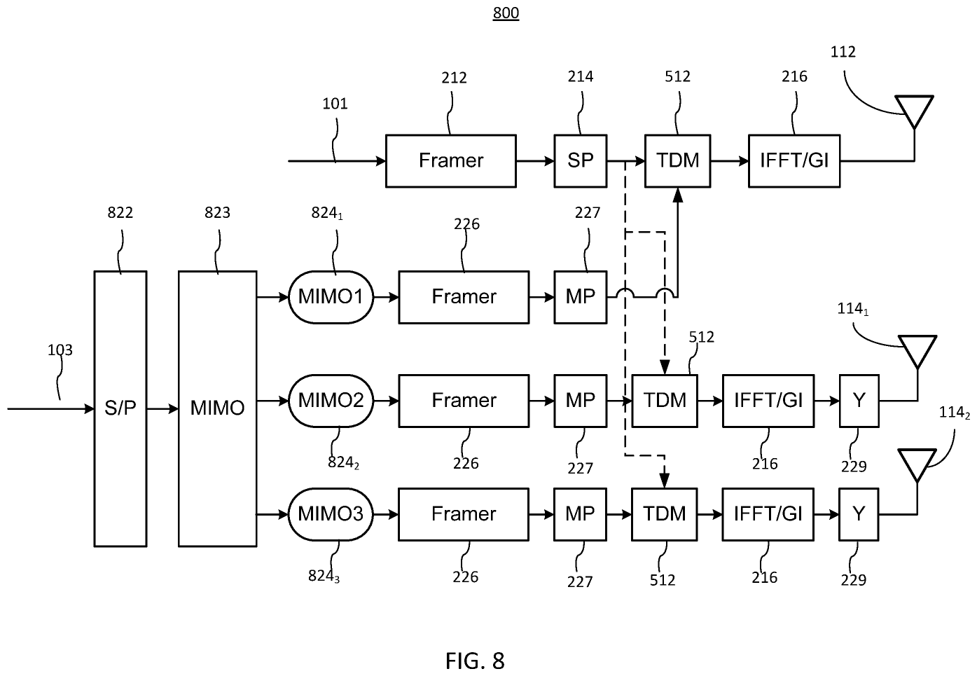

FIG. 8 illustrates an embodiment 800 of the Tx signal processor 500 that is configured to transmit the ITC signal 103 using 3×3 MIMO and two second Tx antennas, 114₁ and 114₂. In this embodiment, the S/P unit 222 and the MIMO encoder 223 are implemented with a 3×3 S/P unit 822 and a 3×3 MIMO encoder 823, respectively. In FIG. 8 and FIG. 5, elements indicated with same reference numerals perform same functions. The 3×3 MIMO encoder 823 outputs three MIMO-encoded ITC data sub-streams, i.e., 824₁ (“MIMO1”), 824₂ (“MIMO2”), and 824₃ (“MIMO3”). Each of these MIMO-encoded ITC data sub-streams is processed as described above by a corresponding signal processing chain, each being TD-multiplexed with the similarly processed broadcast signal 103 and passed to a corresponding one of the three Tx antennas 112, 114₁, and 114₂ for 3×3 wireless MIMO transmission. A co-located Rx signal processor 124 may be implemented using an embodiment of the Rx signal processor 610 of FIG. 6 that is configured for 3×3 MIMO reception and decoding, with a third Rx antenna 116 added.

Other embodiments may be configured for N×N MIMO transmission of ITC signals using (N−1) additional Tx antennas 114 and N Rx antennas 116, where N≥3. The additional Tx antennas 114 may be implemented with directional Tx antennas, with the corresponding Tx signal processing chains including a power control unit 229 to adjust the power of the signal streams at the corresponding additional Tx antenna. In some embodiments configured for N×N MIMO transmission of ITC signals, N_{V}≥1 antennas may be set up for V polarization, and N_{H}≥1 antennas may be set up for H polarization, where N_{V}+N_{H}=N.

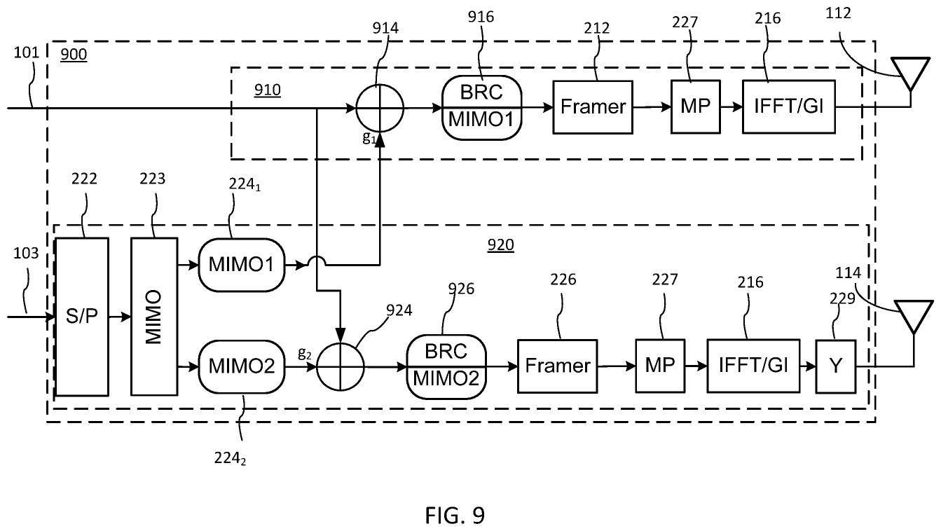

FIGS. 9-17 illustrate example embodiments of the communication apparatus 120 of the TTS 110A, wherein MIMO-encoded sub-steams of the ITC signal 103 are multiplexed with the broadcast signal 101 using layer-division multiplexing (LDM). Some of such embodiments may use a pilot encoding scheme that includes orthogonal pilot patterns for the broadcast and ITC signals to facilitate successive channel estimation in LDM.

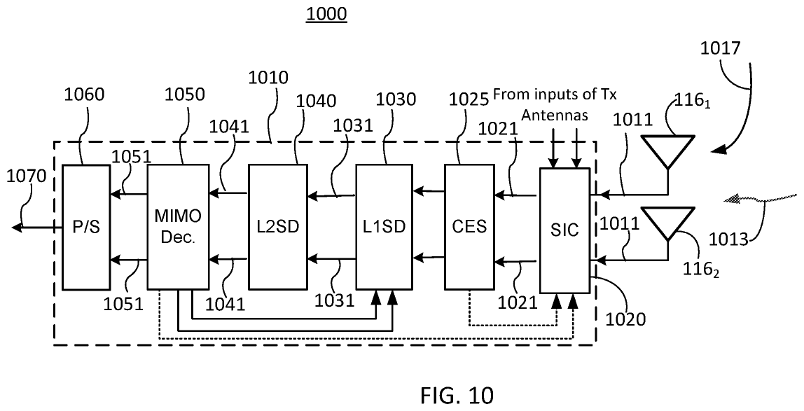

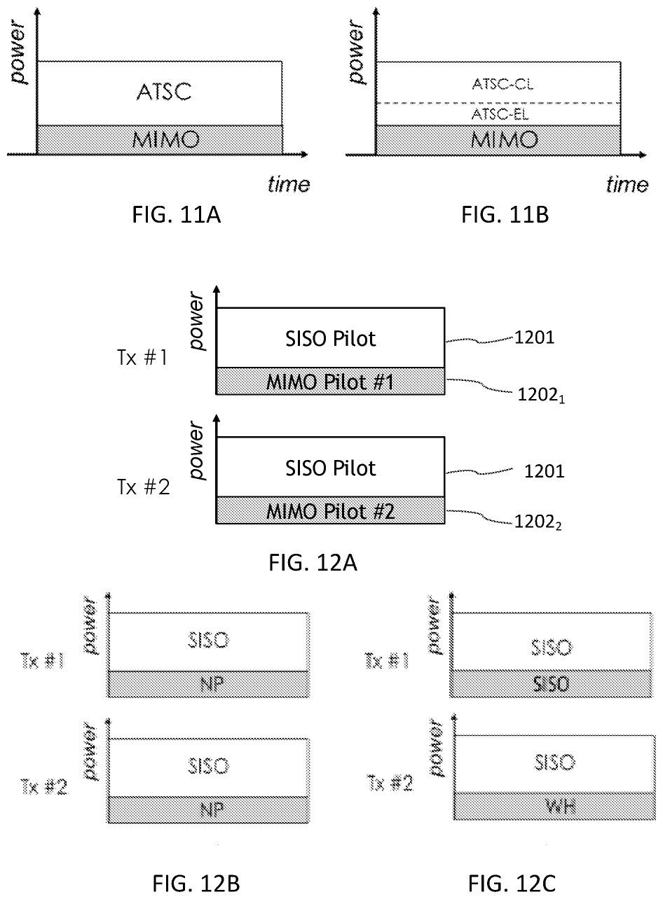

FIG. 9 shows a schematic block diagram of a Tx signal processor 900, which may embody the Tx signal processor 122 of FIG. 1; elements indicated with same reference numerals as in FIG. 2, FIG. 5, or FIG. 8 have same functions. FIG. 10 shows a schematic block diagram of an Rx receiver 1000 including an Rx signal processor 1010. The Rx signal processor 1010 may be an embodiment of the Rx signal processor 124 of FIG. 1, which may be co-located at the same TTS with the Tx signal processor 900. Although 2×2 MIMO configurations are illustrated by way of example, an extension to N×N MIMO encoding will be apparent based on the provided description. FIGS. 11A, 11B illustrate example LDM/MIMO signal structures that may be generated by the Tx signal processor 900 or processed by the Rx signal processor 1010. Each frame of the resulting LDM signal may include n subframes, with both the broadcast (e.g. ATSC 3.0 compliant) signals and MIMO-encoded ITC signals being transmitted on the same subframes 0 to n−1 in different LDM layers.

Referring to FIG. 9, in this embodiment the Tx signal processor 900 includes two signal processing chains, 910 and 920, each of which is configured to superimpose upon the broadcast signal 101 a corresponding one of the MIMO-encoded ITC sub-streams 224₁ (“MIMO1”) and 224₂ (“MIMO2”) using LDM units 914 and 924, to obtain two LDM sub-streams 916 and 926. The LDM sub-streams 916 and 926 include the broadcast signal 101, e.g. at the first LDM layer “L1”, and the corresponding one of the MIMO-encoded ITC sub-streams 224₁ MIMO1 and 224₂ MIMO2 as the lower LDM layer, e.g. “L2” or “L3”. The broadcast signal 101 may be a one-layer signal as shown in FIG. 11A, or a two-layer LDM signal as shown in FIG. 11B. The MIMO sub-streams 224₁ and 224₂ are subjected to a power injection level gᵢ, where i=1 or 2 is the MIMO sub-stream index, before being combined with the broadcast signal 101 as the second (FIG. 11A) or the third (FIG. 11B) LDM layer. The power of the corresponding MIMO sub-stream MIMO1 or MIMO2 is thus gᵢ (dB) below the power of the broadcast signal. Typical gᵢ values may be e.g. in a −5 db to −15 dB range.

Each of the resulting LDM sub-streams 916 and 926 may then be processed as described above, with the MP insertion units 227 adding a MIMO pilot (MP) to each of the LDM subs-streams. The MP can be a one-layer signal or a two-layer signal. One of the two LDM/MIMO sub-streams, e.g. 916, is then transmitted by the main Tx antenna 112, e.g. in the horizontal (H) polarization, while the other of the two LDM/MIMO sub-streams, e.g. 926, is transmitted by the second Tx antenna 114, e.g. in the vertical (V) polarization. Legacy broadcast receivers are typically configured to receive the H-polarization, and may treat the lower-power MIMO signal as tolerable interference. Due to the orthogonality between the H and V polarizations, legacy broadcast receivers that only receive signals from the H polarization may be subject to low-level interference from the V polarization due to the cross-polarization leakage. Thus, in some embodiments, the injection coefficients g₁ and g₂ may be different, e.g. so that the MIMO2 signal 224₂ has a relatively higher power in the LDM sub-stream 926 than the MIMO1 224₁ signal in the LDM sub-stream 916.

Referring now to FIGS. 12A-12C, the Tx signal processor 900 may use various pilot encoding schemes to facilitate channel estimation at the receiver for both legacy (e.g. ATSC 3.0 compliant single-antenna) end-user broadcast receivers and TTS MIMO receivers, such as the MIMO receiver 1000 illustrated in FIG. 10. In an example embodiment, the MP insertion units 227 of the Tx signal processor 900 may implement a pilot encoding scheme that is configured to facilitate, at the MIMO receiver site, the channel estimation for the upper LDM layer(s) carrying the broadcast signal, followed by another channel estimation on the lower LDM layer carrying the MIMO signals. In embodiments illustrated in FIG. 12A-12C, the pilots are two-level signals, with the MP insertion units 227 configured to add a first pilot signal 1201 (“SISO pilot”, or “SP”) in the first LDM layer “L1” and add a second pilot signal 1202ᵢ (“MIMO pilot”, or MP) at the lower LDM layer; here, the subscript “i” indicates a MIMO sub-stream, or, equivalently, a Tx antenna used to transmit the sub-stream; in the illustrated example, i=1 indicates a MIMO signal transmitted by the first Tx antenna 112, and i=2 indicates a MIMO signal transmitted by the second Tx antenna 114. The first LDM layer includes broadcast signals intended for broadcast, e.g. ATSC 3.0 compliant, receivers of end-users. The lower LDM layer includes signals intended for the TTS MIMO receivers, e.g. such as the MIMO receiver 1000. The first pilot signal 1201 and the second pilot signal(s) 1202ᵢ may use the same pilot pattern in the time-frequency grid or different pilot patterns. The first pilot signal 1201 and the second pilot signal(s) 1202ᵢ may use the same reference sequence or different, e.g. orthogonal, reference sequences. The pilot patterns and the reference sequences may be e.g. as defined by physical layer protocol specifications of the ATSC 3.0 standards.

In some embodiments both the SISO pilot 1201 and MIMO pilot(s) 1202ᵢ for each Tx antenna may have the same pilot pattern; such a scheme may be referred to as “one sequence two layers” (1S2L) pilot encoding. In other pilot encoding schemes the SISO and MIMO pilots may have different pilot patterns for a same Tx antenna. Two example embodiments are illustrated in FIGS. 12B and 12C. In the embodiment of FIG. 12B, the same SISO pilot encoding is used in the upper layer of LDM signals transmitted by the first Tx antenna 112 (“Tx #1” in FIGS. 12A-12C) and the second Tx antenna 114 (“Tx #2” in FIGS. 12A-12C). At the lower layer, the NP encoding scheme may be used. In the embodiment of FIG. 12C, a same SISO pilot is used in both layers of signals transmitted by the first Tx antenna 112. Signals transmitted by the second Tx antenna 114 use two-layer pilot encoding, with the SISO pilot in the upper layer and the WH encoding in the lower layer.

Referring back to FIG. 10, the Rx signal processor 1010 is configured to process signals 1011 received from each of the Rx antennas 116₁, 116₂ to detect therein an ITC signal transmitted, e.g. in a lower LDM layer, by another, “partner” TTS, e.g. the second ITC signal 105 transmitted by the TTS 110B (FIG. 1). Signals 1011 received by the Rx signal processor 1010 from the Rx antennas 116_{1,2} may include contributions from an ITC-carrying LDM signal 1013 transmitted by the partner TTS, and a self-interference signal 1017 from the Tx antennas 112, 114 of the co-located broadcast transmitter, e.g. the broadcast transmitter illustrated in FIG. 9.

The Rx signal processor 1010 may be configured to detect lower-layer MIMO-encoded ITC signals using SISO and MIMO pilots of LDM signals such as those described above with reference to FIGS. 11A-12C. In the illustrated embodiment, the Rx signal processor 1010 includes a SIC unit 1020 followed by a channel estimation and synchronization (CES) unit 1025 and successive LDM decoding units 1030 and 1040, which are in turn followed by a MIMO-decoder 1050.

The SIC unit 1020 is configured to perform the SIC processing to approximately cancel the contribution of the self-interference signal 1017, e.g. as described above with reference to SIC 620 of FIG. 6. In some embodiments, the SIC unit 1020 may be configured to approximately cancel the self-interference signal 1017 based, at least, on a feedback from at least one of the CES unit 1025 and the MIMO decoder 1050. In some embodiments, the SIC unit 620 and/or 1020 may be configured to have two SIC stages, a first stage to perform SIC at the analog radio frequency (RF) signal, and the second stage performs SIC at the digital/baseband signal. An example of such two-stage SIC processing is described e.g. in a publication by Z. Hong et al., “Blind RF self-interference cancellation for in-band distribution link in ATSC 3.0,” 2022 IEEE International Symposium on Broadband Multimedia Systems and Broadcasting (BMSB), Bilbao, Spain, 2022, pp. 1-6, dci: 10.1109/BMSB55706.2022.9828730, which is incorporated here by reference in its entirety.

The CES unit 1025 is configured to perform upper-layer channel estimation and received signal synchronization based, e.g., on detecting a SISO pilot of a known time-frequency structure in the signal(s) 1021 received from the SIC unit 1020. The first LDM decoding unit 1030 is configured to perform core-layer (“CL”, or L1), signal detection and cancellation (L1SD) for signals received from the SIC unit 1020. The second LDM decoding unit 1040 is configured to perform enhanced-layer (“EL”, or “L2”) signal detection (L2SD). The MIMO decoder 1050 is configured to perform the MIMO decoding of signals detected in the second layer. The term “core layer”, or “CL”, refers to the first (“L1”), or the highest-power LDM layer(s) carrying the broadcast signal. The term “enhanced layer”, or “EL”, refers to the second (“L2”), lower, LDM layer carrying relatively lower-power signals superimposed upon the first-layer LDM signals subject to an injection level gᵢ.

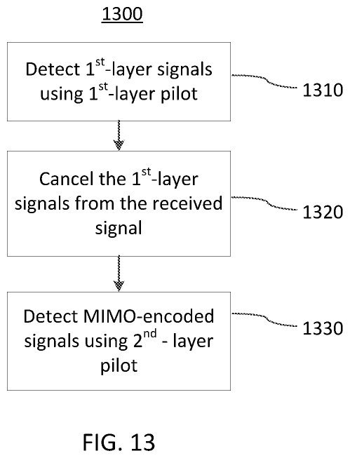

Referring now also to FIG. 13, the Rx signal processor 1010 may implement method 1300 that includes operations 1310, 1320, and 1330. The operations 1310 and 1320, performed by the CES unit 1025 and the L1SD unit 1030 of the Rx signal processor 1010, include: (1310) detecting, for each of the Rx antennas 116 in a corresponding SIC-processed signal 1021, a signal transmitted in the first LDM layer based on a known structure of the first pilot signal(s) (e.g. “SISO pilot” 1201, FIG. 12A); (1320) at least partially cancelling the detected first-layer signal from the received LDM signal 1021 to obtain a residual signal 1031; and (1330) detecting MIMO-encoded sub-streams 1041 of the second ITC signal in the residual signals 1031 using the second pilot signal (e.g. “MIMO pilots” 1202₁ and 1202₂, FIG. 12A).

In an embodiment, the operation 1310 may include performing a least-square (LS) channel estimation based on the signals 1011 received from the Rx antennas 116 or the SIC-processed signals 1021, and the known structure of the first layer pilot signals (e.g. “SISO-pilot” 1201, FIG. 12A). At this step, the lower-level pilot signals (e.g. “MIMO-pilots” 1202ᵢ, FIG. 12A) may be treated as noise. In some embodiments, the operation 1310 may further include applying a time and frequency domain 2-D filter to the LS channel estimates for improved accuracy. The operation 1310 may further include combining the filtered signals received from the Rx antennas 116 using, e.g., a maximum-ratio combining algorithm, to decode the upper-layer broadcast signal.

In an embodiment, the operation 1320 may include cancelling the decoded broadcast signal and the upper-layer pilots from, e.g., the SIC-processed received signals 1021 to obtain a residual signal 1031 for each of the antenna signals 1011.

In an embodiment, the operation 1330 may include performing a lower-level channel estimation based on the residual signals 1031 and the known structure of the second-layer pilots (e.g. “MIMO-pilots” 1202ᵢ, FIG. 12A). The operation 1330 may further include performing MIMO decoding, which includes obtaining estimates 1051 of the transmitted data sub-streams for each of the MIMO channels (“decoded MIMO sub-streams 1051”). The operation 1330 may further include combining the decoded MIMO sub-streams 1051 using a parallel to serial combiner (P/S) 1060 to obtain an estimate 1070 of the transmitted ITC signal.

For an embodiment with a same pilot pattern 1201, the above described processing may be illustrated using, e.g. the following mathematical description. Let S denote the SISO pilot 1201 at the upper layer (UL), U₁ and U₂ denote the lower layer (LL) pilots 1202₁ and 1202₂ transmitted by the first and second Tx antennas, respectively. The transmit signal (pilot) X₁ and X₂ at the Tx antennas can be approximately written as:

X₁=S+ρU₁

X₂=S+ρU₂

The received signal R at an ATSC 3.0 compliant receiver can be approximately written as:

R=h₁X₁+h₂X₂+n=(h₁+h₂)S+ρ(h₁U₁+h₂U₂)+n=hS+n′

Here h₁ and h₂ are the channel gains between an Rx antenna and the two Tx antennas respectively, h=h₁+h₂ is a combined channel gain, n is an additive white Gaussian noise (AWGN), and n′=ρ(h₁U₁+h₂U₂)+n denotes a composite noise term.

An ATSC 3.0 compliant receiver can perform an LS channel estimation on the UL pilot 1201. The LS channel estimates may then be filtered using a time-frequency domain 2D filter for improved accuracy. The LL pilots are treated as noise due to their relatively lower power as compared to UL signals, as defined by an LL injection level p. The LS channel estimation at the ATSC 3.0 compliant receiver can be approximately written as:

$$\tilde{h} = \frac{{S}^{*}}{{\vert S \vert}^{2}} R$$

Signals Rᵢ received at Rx antennas of a MIMO receiver, e.g. the Rx antennas 116 of the MIMO receiver 1000, can be written approximately as:

R₁=h₁₁X₁+h₁₂X₂+n₁=(h₁₁+h₁₂)S+ρ(h₁₁U₁+h₁₂U₂)+n₁

R₂=h₂₁X₁+h₂₂X₂+n₂=(h₂₁+h₂₂)S+ρ(h₂₁U₁+h₂₂U₂)+n₂

Here hᵢⱼ is the channel gain between an i-th Rx antenna and a j-th Tx antenna, and nᵢ is the AWGN at the i-th Rx antenna.

At each Rx antenna of the MIMO receiver, the LS channel estimation on the UL pilot is performed. The LS channel estimates may then be filtered with a time-frequency domain 2D filter for improved accuracy. With the UL channel estimates, the MIMO receiver can apply a maximum ratio combining algorithm to combine the Rx signals to decode the UL signals. After UL channel estimation and decoding, the UL is then cancelled from the received signals, including the pilots. The receivers can perform MIMO channel estimation on the MP which is at the LL of the pilots.

For a nearly-perfect UL cancellation, the MIMO-level pilot signals Rᵢ′ received at the Rx antennas could be estimated as follows:

R₁′=ρh₁₁U₁+ρh₁₂U₂+n₁

R₂′=ρh₂₁U₁+ρh₂₂U₂+n₂

The MIMO receiver may group two consecutively received pilots together to form the matrix representation as follows:

$$[ \begin{matrix}{R}_{1 , k}^{′} & {R}_{2 , k}^{′} \\ {R}_{1 , k + 1}^{′} & {R}_{2 , k + 2}^{′}\end{matrix} ] = ρ [ \begin{matrix}{U}_{1 , k} & {U}_{2 , k} \\ {U}_{1 , k + 1} & {U}_{2 , k + 1}\end{matrix} ] [ \begin{matrix}{h}_{11} & {h}_{21} \\ {h}_{12} & {h}_{22}\end{matrix} ] + [ \begin{matrix}{n}_{1 , k} & {n}_{2 , k} \\ {n}_{1 , k + 1} & {n}_{2 , k + 1}\end{matrix} ]$$

with the index k indicating the timing of the pilot.

The LS channel estimation may be obtained by multiplying the inverse of the pilot matrix as follows:

$$[ \begin{matrix}{\tilde{h}}_{11} & {\tilde{h}}_{21} \\ {\tilde{h}}_{12} & {\tilde{h}}_{22}\end{matrix} ] = {\frac{1}{ρ Δ} [ \begin{matrix}{U}_{1 , k} & {U}_{2 , k} \\ {U}_{1 , k + 1} & {U}_{2 , k + 1}\end{matrix} ]}^{†} [ \begin{matrix}{R}_{1 , k}^{′} & {R}_{2 , k}^{′} \\ {R}_{1 , k + 1}^{′} & {R}_{2 , k + 1}^{′}\end{matrix} ]$$

where t is the Hermitian operation and A is the determinant of the pilot matrix:

$$Δ = det [ \begin{matrix}{U}_{1 , k} & {U}_{2 , k} \\ {U}_{1 , k + 1} & {U}_{2 , k + 1}\end{matrix} ]$$

For the NP encoding scheme,

$$[ \begin{matrix}{U}_{1 , k} & {U}_{2 , k} \\ {U}_{1 , k + 1} & {U}_{2 , k + 1}\end{matrix} ] = [ \begin{matrix}\sqrt{2} {a}_{k} & 0 \\ 0 & \sqrt{2} {a}_{k}\end{matrix} ]$$

$$Δ = 2 {\vert {a}_{k} \vert}^{2}$$

and the LS channel estimate of hᵢⱼ may be as given by the following equations:

$${\tilde{h}}_{ij} = \frac{\sqrt{2}}{2 ρ} {R}_{ij}^{′} = {h}_{ij} + \frac{\sqrt{2}}{2 ρ} {n}_{ij}$$

The SNR of the LS channel estimate of hᵢⱼ may be estimated as follows:

$$SNR ( {\tilde{h}}_{ij} ) = \frac{2 {ρ}^{2}}{{σ}^{2}}$$

For WH encoding, the pilot matrix can be written as

$$[ \begin{matrix}{U}_{1 , k} & {U}_{2 , k} \\ {U}_{1 , k + 1} & {U}_{2 , k + 1}\end{matrix} ] = [ \begin{matrix}{a}_{k} & {a}_{k} \\ {a}_{k + 1} & - {a}_{k + 1}\end{matrix} ]$$

The LS channel estimates in the matrix form can be written as

$$[ \begin{matrix}{\tilde{h}}_{11} & {\tilde{h}}_{21} \\ {\tilde{h}}_{12} & {\tilde{h}}_{22}\end{matrix} ] = \frac{1}{2 ρ ( {\vert {a}_{k} \vert}^{2} + {\vert {a}_{k + 1} \vert}^{2} )} [ \begin{matrix}{a}_{k}^{*} & {a}_{k + 1}^{*} \\ {a}_{k}^{*} & - {a}_{k + 1}^{*}\end{matrix} ] [ \begin{matrix}{R}_{1 , k}^{′} & {R}_{2 , k}^{′} \\ {R}_{1 , k + 1}^{′} & {R}_{2 , k + 1}^{′}\end{matrix} ] = \frac{1}{2 ρ ( {\vert {a}_{k} \vert}^{2} + {\vert {a}_{k + 1} \vert}^{2} )} {R}^{′}$$

The LS channel estimates may be filtered using a suitable time-frequency domain 2D filter for improved accuracy, and the MIMO decoding performed using the obtained channel estimates.

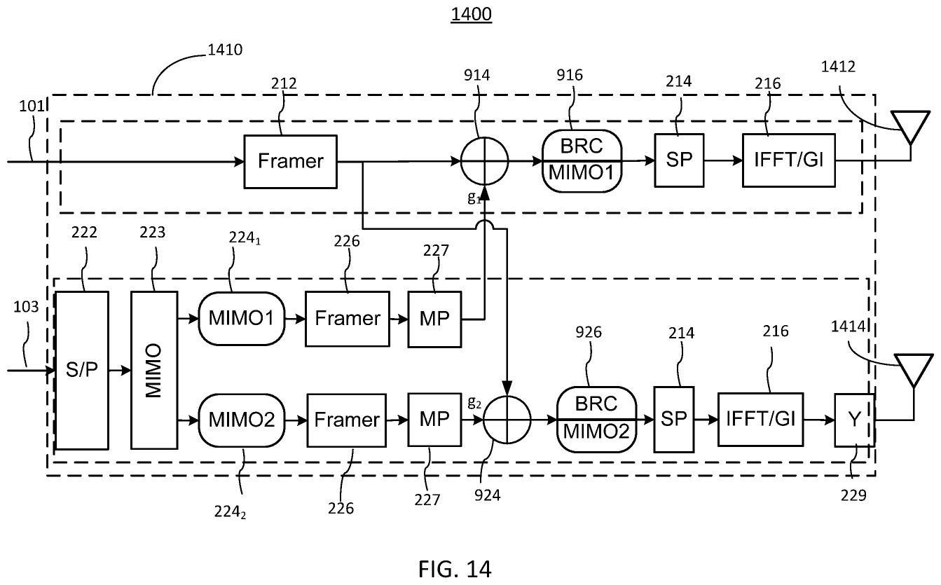

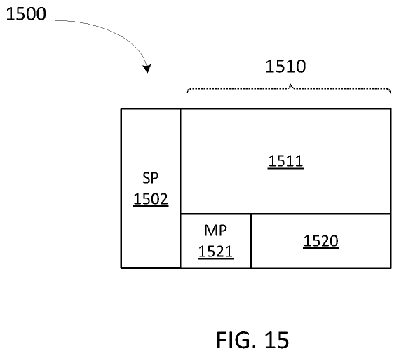

FIG. 14 illustrates a broadcast transmitter 1400 including a Tx signal processor 1410, a broadcast Tx antenna 1414, and an additional Tx antenna 1414. The Tx signal processor 1410 and the Tx antennas 1412, 1414 may be embodiments of the Tx signal processor 122 and the Tx antennas 112, 114 respectively. Elements that are indicated in FIG. 14 and in one of the earlier figures with same reference numerals perform same functions. FIG. 15 schematically illustrates a structure of a signal 1500 that may be generated in this embodiment. The Tx signal processor 1410 is configured to insert two single-layer pilot sequences, “MP” (1521, FIG. 15) and “SP” (1502, FIG. 15), using the MIMO pilot insertion units 227 and the SISO pilot insertion units 214, respectively. The signal 1500 includes a single-layer SISO pilot sequence “SP” 1502 appended to an LDM signal 1510. The single-layer pilot sequence 1502 may be synchronously inserted by the SP units 214 into the signal sub-streams provided to the Tx antennas 1412, 1414. The LDM signal 1510 in this embodiment includes first-layer signals 1511 including the broadcast signal 101. Second-layer signals include a MIMO signal 1520 comprising the MIMO-encoded ITC signal 103, and MP pilot sequence(s) 1521 inserted by the MP units 227.

In the illustrated example, the pilots 1502 and 1521 are one-layer signals. The MP pilot sequence(s) 1521 are inserted into the MIMO sub-streams prior to combining with the broadcast stream. The SP pilot sequence 1502 is synchronously added by the SP units 214 to the LDM sub-streams 916, 926 after the broadcast signal is LDM-multiplexed with the MIMO-encoded ITC signal sub-streams 224₁, 224₂ by the LDM combiners 914 and 924. The MP pilot sequence 1521 only appears at the lower-layer MIMO streams, and it occupies a different time and/or frequency position in the frame than the SP pilot 1502. This two-set one-layer pilot encoding scheme may be referred to as the 2S1L pilot encoding.

In this embodiment, ATSC 3.0 compliant receivers can perform channel estimation using the SP pilot sequence 1502. MIMO receivers, such as e.g. the TTS MIMO receiver 1000, may use the MP pilot sequence(s) 1521 to perform channel estimation after the initial channel estimation using the SP pilot 1502 followed by the broadcast signal detection and an approximate cancellation of the upper-layer broadcast signal 1511, e.g. as described above with reference to FIGS. 10 and 13. The MIMO pilot encoding scheme used by the MP insertion units 227 may be, e.g., as defined by the ATSC 3.0 Standards, e.g. the NP or WH encoding, or any other suitable encoding scheme.

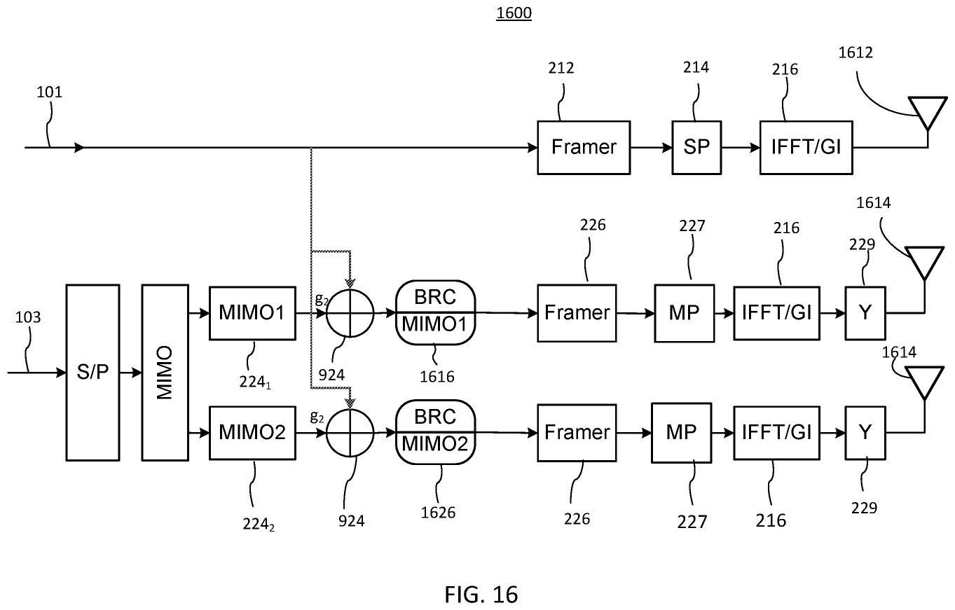

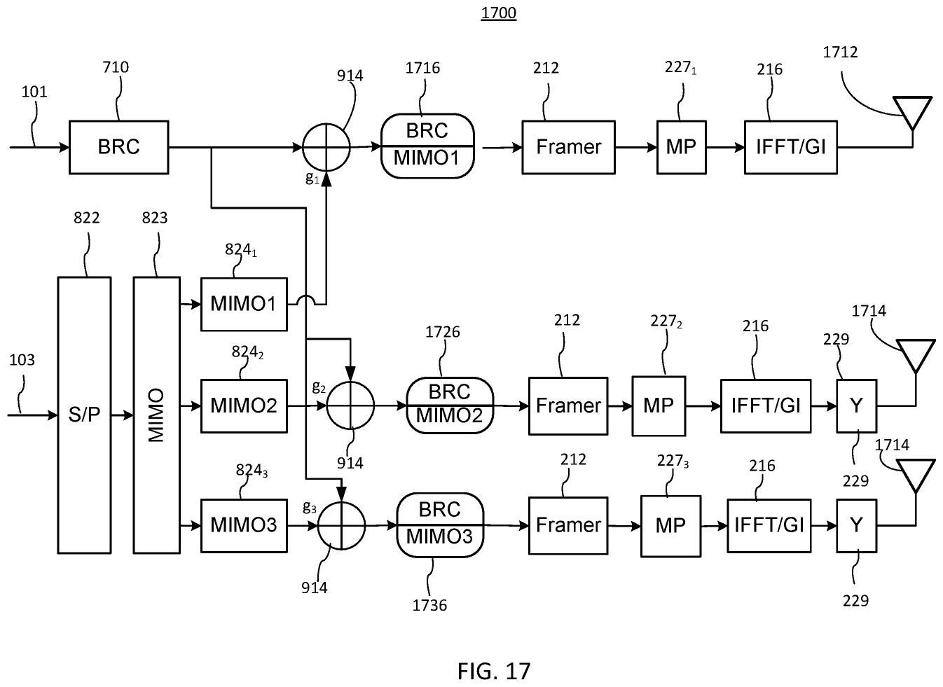

FIGS. 16 and 17 illustrate two example embodiments of a broadcast transmitter having two additional Tx antennas configured for MIMO transmission of the ITC signal 103 in a lower LDM layer. Elements that are indicated in FIG. 16 or 17 with same reference numerals as corresponding elements in one of the earlier figures perform same functions.

FIG. 16 illustrates a Tx signal processor 1600 in which a main Tx antenna 1612 is used to transmit the broadcast signal 101, while two additional Tx antennas 1614 are used to transmit the MIMO-encoded ITC signal sub-streams “MIMO1” 224₁ and “MIMO2” 224₂. The Tx signal processor 1600 may be an embodiment of the Tx signal processor 122. The Tx antenna 1612 may be an embodiment of the first Tx antenna 112 of the TTS 110A of FIG. 1. The additional Tx antennas 1614 may be embodiments of the second Tx antenna 114 of the TTS 110A of FIG. 1. The MIMO-encoded ITC signal sub-streams “MIMO1” 224₁ and MIMO2” 224₂ are transmitted in the second layer of the LDM signals 1616 and 1626, with the first LDM layer carrying the broadcast signal 103 (“BRC”). In this embodiment, the first Tx antenna 1612 does not transmit the ITC signal. Here the SP unit 214 may be configured to use, e.g., a conventional SISO pilot encoding, e.g. as specified in the ATSC 3.0 standards. The MP insertion units 227 may be configured to use, e.g., either the 1S2L pilot encoding scheme or the 2S1L pilot encoding scheme described above.

FIG. 17 illustrates a Tx signal processor 1700 configured to use a main Tx antenna 1712 and two additional Tx antennas 1714 to MIMO-transmit the ITC signal 103 in the second LDM layer, while transmitting the broadcast signal 101 in the first LDM layer. The Tx signal processor 1700 may be an embodiment of the Tx signal processor 122. The Tx antenna 1712 may be an embodiment of the first Tx antenna 112 of the TTS 110A of FIG. 1, and may transmit in the H polarization. The additional Tx antennas 1714 may each be an embodiment of the second Tx antenna 114 of the TTS 110A of FIG. 1. The additional Tx antennas 1714 may be configured to transmit in the V polarization. The ITC signal 103 is MIMO-encoded by the MIMO encoder 823 to form three data sub-streams “MIMO1” 824₁, “MIMO2” 824₂, and “MIMO3” 824₃. These data sub-streams are then superimposed onto the broadcast signal 101 at corresponding injection levels g₁, g₂ and g₃, by the LDM multiplexers 1716 for transmitting in, e.g., the second LDM layer of LDM signals 1716, 1726, 1736. The LDM signals 1716, 1726, 1736 are then processed as described above and transmitted with the respective one of the Tx antennas 1712, 1714. The injection levels g₂ and g₃ may be greater than the injection level g₁ in embodiments where the Tx antennas 1714 and the Tx antenna 1712 transmit in orthogonal polarizations. All three LDM signal sub-streams 1716, 1726, 1736 may carry the same broadcast signal 103 (“BRC”) in the first layer. In one embodiment, the MP units 227₁, 227₂, and 227₃, of the Tx processor 1700 may be configured to insert a same SISO pilot “SP” in the first LDM layer and different, e.g. mutually orthogonal, MIMO pilots in the second LDM layer, e.g. using the NP encoding. In another embodiment, the MP units 227₁, 227₂, and 227₃, may be configured to add, e.g., mutually-orthogonal MP pilots to the second layer of the LDM sub-streams 1716, 1726, 1736, e.g. using the NP pilot encoding, and to append a single-layer SISO pilot to each of the LDM sub-streams 1716, 1726, 1736, e.g. as illustrated in FIG. 15. The SISO and MP pilots may be different, in some embodiments statistically independent, signal sequences.

The broadcast transmitter illustrated in FIG. 17 may be co-located at the same TTS with an embodiment of the MIMO receiver 1000 described above with reference to FIGS. 10 and 13, which is modified for 3×3MIMO decoding.

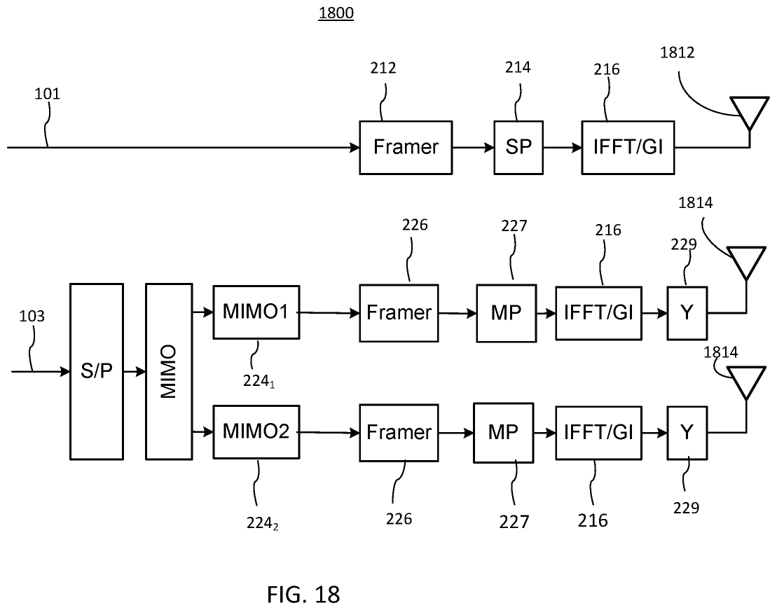

FIG. 18 illustrates a broadcast transmitter 1800 wherein the broadcast signal 101 and the ITC signal 103 are independently transmitted using a broadcast Tx antenna 1812 and one or more additional directional Tx antennas 1814. The broadcast Tx antenna 1812 and the one or more additional directional Tx antennas 1814 may be embodiments of the Tx antennas 112 and 114 respectively, with the Tx antennas 1814 transmitting in the V polarization that is orthogonal to the H polarization of the broadcast Tx antenna 1812. In this embodiment, the broadcast signal and the ITC signal may be simultaneously transmitted by different Tx antennas and are spatially multiplexed. Here, “spatially” refers to the multiplexing of wireless signals generated by different, spaced apart Tx antennas having different transmission directionality and/or polarization. Other embodiments may include N additional antennas 1814, with N≥1, for SISO or N×N MIMO transmission of the ITC signal 103.

Principles and techniques described herein may be used to integrate the delivery of conventional and new generation broadcast services, flexible datacasting services, and point-to-point internet services using over-the-air broadcast infrastructure and broadcast-allocated frequency bands. In some implementations, broadcast services and ITC signals may be transmitted in separate frequency bands. Multiple ITC-integrating broadcast communication systems may be connected to a core broadcast network (CBN) supporting the delivery of flexible local and shared broadcasting, datacasting, and point-to-point, e.g., internet, services over a broad geographical area. ITC support may be integrated into a broadcast on-channel repeater (OCR), which may enable a low-cost broadcast/ITC relay station providing additional coverage.

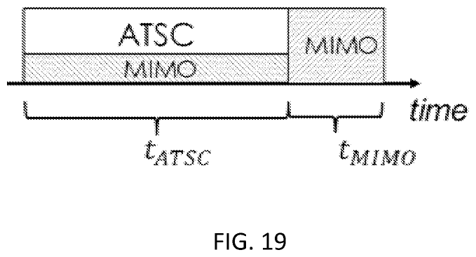

The above-described exemplary embodiments are intended to be illustrative in all respects, rather than restrictive, of the present invention. Indeed, various other embodiments and modifications to the present disclosure, in addition to those described herein, will be apparent to those of ordinary skill in the art from the foregoing description and accompanying drawings. Furthermore, each of the example embodiments described hereinabove may include features described with reference to other embodiments. For example, the example broadcast transmitters and MIMO receivers described above may be modified to multiplex broadcast and ITC signals using a combination of TDM and LDM multiplexing, e.g. as illustrated in FIG. 19. Furthermore, any of the example embodiments described above may be modified to include two or more second, additional Tx antennas for N×M MIMO encoding of ITC signals, each of which may be a directional Tx antenna. The transmission power of at least some, or each, of these additional Tx antenna may be controlled to equalize the wireless power received from each of the Tx antennas at the “partner” TTS. In some of such embodiments, the Rx signal processors of the transmitting TTS may be configured to extract, from a MIMO signal received from the partner TTS, a feedback signal for controlling the transmission power of the co-located directional Tx antennas. Furthermore, each of the example embodiments described above the additional, second Tx antennas may be configured to transmit in a polarization that is orthogonal to the polarization of the wireless signals transmitted by the first, broadcast Tx antenna. Each of the example embodiments described above, may be configured so that at least one of the additional, second Tx antennas transmits in a same polarization as the first, broadcast Tx antenna. Furthermore, some of the embodiments may be configured or modified so that the broadcast antenna and at least one of the additional antennas each transmit in dual-polarization, i.e. both in the H and V polarizations.

Furthermore, in the description above, for purposes of explanation and not limitation, specific details are set forth such as particular architectures, interfaces, techniques, etc. in order to provide a thorough understanding of the present invention. In some instances, detailed descriptions of well-known devices, circuits, and methods are omitted so as not to obscure the description of the present invention with unnecessary detail. Thus, for example, it will be appreciated by those skilled in the art that block diagrams herein can represent conceptual views of illustrative circuitry embodying the principles of the technology. All statements herein reciting principles, aspects, and embodiments of the invention, as well as specific examples thereof, are intended to encompass both structural and functional equivalents thereof.

What is claimed is:

1. A communication apparatus for a transmitter tower station (TTS) of a broadcast communication system (BCS), the apparatus comprising:
a first transmitter (Tx) antenna configured to transmit a broadcast signal to a plurality of customer receivers;
one or more second Tx antennas configured to transmit a first ITC signal to another TTS;
a Tx signal processor coupled to the first Tx antenna and the one or more second Tx antennas and configured to perform a multi-input multi-output (MIMO) encoding of the first ITC signal to transmit a MIMO-encoded first ITC signal with, at least, the one or more second Tx antennas;
at least two receiver (Rx) antennas for receiving, from the another TTS or a third TTS, wireless signals comprising a MIMO-encoded second ITC signal; and
an Rx signal processor configured to decode the MIMO-encoded second ITC signal to extract ITC information therefrom.

2. The apparatus of claim 1 wherein the one or more second Tx antennas comprises a directional Tx antenna having at least 5 dB lower antenna gain than the first Tx antenna.

3. The apparatus of claim 1 wherein the Tx signal processor comprises a gain control unit for adjusting a transmission power of the one or more second Tx antennas so that the another TTS receives approximately equal signal power from at least one of the one or more second Tx antennas and the first Tx antenna.

4. The apparatus of claim 3 wherein the Tx signal processor is configured to adjust the transmission power of the one or more second Tx antennas responsive to a feedback signal from the another TTS.

5. The apparatus of claim 1 wherein the Tx signal processor is configured for transmitting the broadcast signal with the first Tx antenna and at least one of the one or more second Tx antenna.

6. The apparatus of claim 1 wherein the Tx signal processor is configured to time-multiplex the broadcast signal and the MIMO-encoded first ITC signal.

7. The apparatus of claim 1 wherein the Tx signal processor is configured to generate a first layered division multiplexed (LDM) signal having the broadcast signal and the MIMO-encoded first ITC signal in different LDM layers.

8. The apparatus of claim 7 wherein the Tx signal processor is configured to add different pilot signals to the different LDM layers.

9. The apparatus of claim 1 wherein the Rx signal processor is configured to process a received LDM signal comprising first and second LDM layers, the first and second LDM layers comprising first and second pilot signals respectively, the second LDM layer comprising the received MIMO-encoded second ITC signal.

10. The apparatus of claim 9 wherein the Rx signal processor is configured to: detect a first-layer signal transmitted in the first LDM layer using the first pilot signal, at least partially cancel the detected first-layer signal from the received LDM signal to obtain a residual signal, and to detect the MIMO-encoded second ITC signal in the residual signal using the second pilot signal.

11. The apparatus of claim 1 wherein the one or more second Tx antennas comprise two directional Tx antennas, and wherein the Tx signal processor is configured to MIMO-encode the first ITC signal for transmitting with the first Tx antenna and the two directional Tx antennas.

12. The apparatus of claim 1 wherein the Rx signal processor comprises a self-interference cancellation unit to approximately cancel an interference signal from, at least, the first Tx antenna.

13. The apparatus of claim 1 wherein the first Tx antenna and at least one of the one or more second Tx antennas are configured to transmit in orthogonal polarizations.

14. The apparatus of claim 1 wherein the first Tx antenna and at least one of the one or more second Tx antennas are configured to transmit in a same polarization.

15. The apparatus of claim 1 wherein the first Tx antenna and at least one of the one or more second Tx antennas are each configured to transmit in two orthogonal polarizations.

16. The apparatus of claim 1 wherein the first Tx antenna is an omni-directional antenna.

17. The apparatus of claim 16 wherein each of the one or more second Tx antennas is a directional antenna.

18. The apparatus of claim 12 wherein the self-interference cancellation unit is configured to approximately cancel the interference signal based, at least, on signals generated by the Tx signal processor.

19. The apparatus of claim 12 wherein the Rx signal processor further comprises a channel estimation and synchronization unit and a MIMO decoding unit, and wherein the self-interference cancellation unit is configured to approximately cancel the interference signal based, at least, on a feedback from at least one of the channel estimation unit and the MIMO decoding unit.

20. A method for a transmitter tower station (TTS) of a broadcast communication system (BCS), the method comprising:
transmitting a broadcast signal to a plurality of customer receivers with a first transmitter (Tx) antenna;
performing a multi-input multi-output (MIMO) encoding of a first inter-tower communication (ITC) signal;
transmitting the MIMO-encoded first ITC signal to another TTS with, at least, one or more second Tx antennas;
receiving wireless signals with two or more Rx antennas, the wireless signals comprising a MIMO-encoded second ITC signal transmitted by the another TTS or a third TTS; and
decoding the MIMO-encoded second ITC signal to extract ITC information therefrom.
